(19) United States
(12) Patent Application Publication
(10) Pub. No.: US 2024/0253957 A1
(43) Pub. Date: Aug. 1, 2024

(54) CANOPY DEPLOYMENT AND RETRACTION DEVICE WITH LINE TENSION CONTROL

(71) Applicant: Maritime Applied Physics Corporation, Baltimore, MD (US)

(72) Inventors: Kevin Wade Silbert, Columbia, MD (US); James Nathaniel Chafe, Annapolis, MD (US)

(21) Appl. No.: 18/103,397

(22) Filed: Jan. 30, 2023

(51) Int. Cl. B66D 1/50; B66D 1/12; B66D 1/39; E04H 15/06

(52) U.S. Cl. CPC B66D 1/50; B66D 1/12; B66D 1/39; E04H 15/06

(57) ABSTRACT

A vehicle comprising a first device and a canopy. The first device includes a first spool device; a first drive screw comprising a threaded portion, wherein the first drive screw is configured to extend through an opening in the first spool device; a first drive motor coupled to the first drive screw, wherein the first drive motor is configured to rotate the first drive screw; a first tension controller device coupled to the first spool device; and a first stop pawl coupled to the first drive screw. The canopy includes a canopy fabric; and a first line, wherein the canopy is coupled to the first spool device through the first line.

This invention was made with government support under Contract N68335-20-C-0356 awarded by Naval Air Warfare Center Aircraft Division. The government has certain rights in the invention.

### FIELD

Various features relate to a canopy deployment and retraction device.

### BACKGROUND

The successful deployment of a canopy requires that there is proper tension on the line throughout the deployment and/or retraction of the line. When there is no proper amount of tension in the line for an extended period of time, the line may get tangled with other lines, which can cause the canopy to fail and/or not properly deploy. As such, there is a need for a device that can automatically maintain the proper level of tension on a line, in order to ensure the proper deployment, retraction and/or steering of a canopy.

### SUMMARY

Various features relate to a canopy deployment and retraction device.

An example provides a vehicle comprising a first device and a canopy. The first device includes a first spool device; a first drive screw comprising a threaded portion, wherein the first drive screw is configured to extend through an opening in the first spool device; a first drive motor coupled to the first drive screw, wherein the first drive motor is configured to rotate the first drive screw; a first tension controller device coupled to the first spool device; and a first stop pawl coupled to the first drive screw. The canopy includes a canopy fabric; and a first line, wherein the canopy is coupled to the first spool device through the first line.

Another example provides a device comprising a spool device; a drive screw comprising a threaded portion, wherein the drive screw is configured to extend through an opening in the spool device; a drive motor coupled to the drive screw, wherein the drive motor is configured to rotate the drive screw; a tension controller device coupled to the spool device; and a stop pawl coupled to the drive screw.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates an exemplary view of a vessel comprising a canopy and a canopy deployment, retraction and/or steering device with line tension control.

FIG. 2 illustrates an exemplary view of a canopy and a canopy deployment, retraction and/or steering device with line tension control.

FIG. 3 illustrates an exemplary view of a canopy deployment, retraction and/or steering device with line tension control.

FIG. 4 illustrates another exemplary view of a canopy deployment, retraction and/or steering device with line tension control.

FIG. 5 illustrates another exemplary view of a canopy deployment, retraction and/or steering device with line tension control.

FIG. 6 illustrates an exemplary assembly view of a canopy deployment, retraction and/or steering device with line tension control.

FIG. 7 illustrates another exemplary assembly view of a canopy deployment, retraction and/or steering device with line tension control.

FIG. 8 illustrates an exemplary assembly view of a canopy deployment, retraction and/or steering device with line tension control.

FIGS. 9A-9H illustrate an exemplary sequence of an operation of a canopy deployment, retraction and/or steering device with line tension control.

FIG. 10 illustrates an exemplary view of a deployed canopy and a canopy deployment, retraction and/or steering device with line tension control.

FIG. 11 illustrates an exemplary view of a semi-retracted canopy and canopy deployment, retraction and/or steering device with line tension control.

FIG. 12 illustrates an exemplary view of a canopy with a line configuration.

FIG. 13 illustrates an exemplary view of a canopy with another line configuration.

FIG. 14 illustrates an exemplary view of a canopy with another line configuration.

FIG. 15 illustrates an exemplary view of a canopy with another line configuration.

FIG. 16 illustrates an exemplary view of a vessel comprising a canopy and a canopy deployment retraction and/or steering device with line tension control.

FIG. 17 illustrates various components of a controller for a canopy deployment, retraction and/or steering device.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The present disclosure describes a vessel comprising a first device and a canopy. The first device includes a first spool device; a first drive screw comprising a threaded portion, wherein the first drive screw is configured to extend through an opening in the first spool device; a first drive motor coupled to the first drive screw, wherein the first drive motor is configured to rotate the first drive screw; a first tension controller device coupled to the first spool device; and a first stop pawl coupled to the first drive screw. The canopy includes a canopy fabric; and a first line, wherein the canopy is coupled to the first spool device through the first line. The first device may be a canopy deployment, retraction and/or steering device. The first device is configured to provide and/or ensure proper tension in a line, which helps in the proper deployment, retraction and/or steering of a canopy. In particular, the first device provides an automated method to ensure there is proper tension in a line of a canopy. The first tension controller device may include a spring motor, which is configured to control and maintain tension in the first line. The first tension controller may be coupled to the first spool device. The first tension controller may be configured to rotate the first spool device when there is little or no tension in the first line.

Exemplary Canopy Deployment, Retraction and/or Steering Device with Line Tension Control

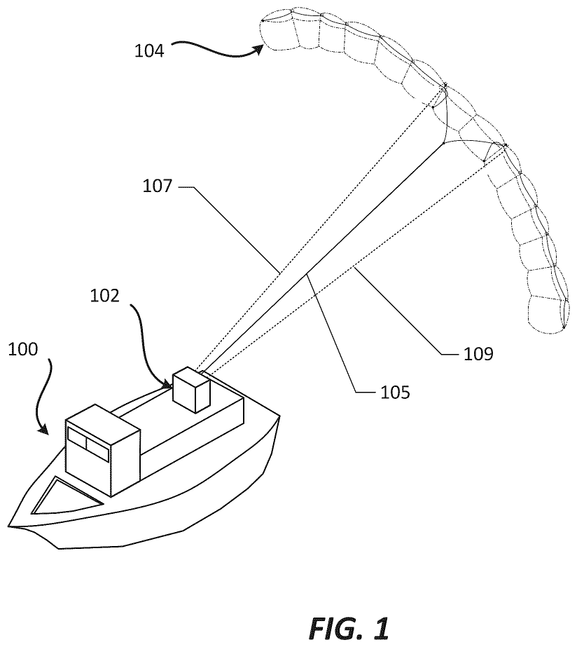

FIG. 1 illustrates a vessel 100 that includes a device 102. The location of the device 102 on the vessel 100 is exemplary. Different implementations may position the device 102 in and/or on different locations of the vessel 100. In some implementations, the device 102 may be coupled to a mast (e.g., extendable mast) of the vessel 100. As will be further described below, the device 102 may be a canopy deployment, retraction and/or steering device. The vessel 100 also includes a canopy 104 that is coupled to the device 102 through a line 105, a line 107 and a line 109. The line 105, the line 107 and/or the line 109 may be considered part of the canopy 104 and/or the device 102. The canopy 104 may be considered part of the device 102. It is noted that each of the line 105, the line 107 and/or the line 109 may conceptually represent one line or they may conceptually represent several lines coupled to the canopy 104 and the device 102. For purposes of simplicity, not all the lines that are coupled to the canopy 104 are shown. The line 105, the line 107 and/or the line 109 are meant to be exemplary lines that may be coupled to the canopy 104. As will be further described below, the device 102 provides an automated method for deploying, retracting and/or steering a canopy, while automatically controlling and/or maintaining the proper tension on one or more lines coupled to a canopy, which helps ensure the proper and successful deployment, retraction and/or steering of a canopy. It is noted that a configuration and/or an operation that is meant for deployment of a canopy may be applicable to a retraction and/or steering of the canopy. Moreover, a configuration and/or an operation that is meant for retraction of a canopy may be applicable to a deployment and/or steering of the canopy. Similarly, a configuration and/or an operation that is meant for steering of a canopy may be applicable to the deployment and/or retraction of the canopy.

The vessel 100 may operate in a body of water, such as a water stream, a waterway, a river, a lake, and an ocean. The body of water may be a human made body of water or a natural body of water. The vessel 100 is an example of a water borne vehicle. The vessel 100 may be implemented as a platform (e.g., floating platform). In some implementations, the vessel 100 may be implemented as part of a ship, a catamaran, which are examples of a water borne vehicle. The device 102 may be implemented as part of a moveable vehicle, a land based vehicle, a water based vehicle, an air based vehicle, an amphibious vehicle and/or a vehicle with a propulsion system. A vehicle may be moveable or fixed. In some implementations, the device 102 may be implemented with a fixed structure, such as a stationary tower, a stationary mast, and/or a building.

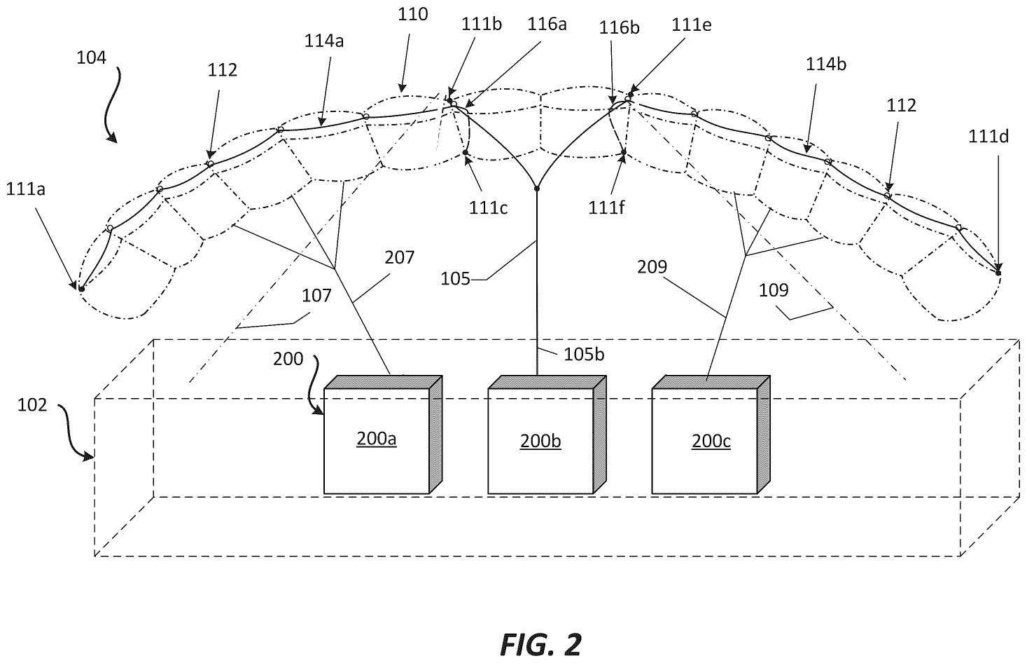

FIG. 2 illustrates the device 102 and the canopy 104. The canopy 104 includes a canopy fabric 110, a plurality of fixed connections 111, a plurality of rings 112 (e.g., plurality of loops), a plurality of lines 114, and a plurality of lines 116, as well as other load-bearing lines with no control functionality. The plurality of fixed connections 111 are coupled to the canopy fabric 110. The plurality of rings 112 are coupled to the canopy fabric 110. The plurality of lines 114 and/or the plurality of lines 116 may be coupled to the canopy fabric 110 through the plurality of fixed connections 111 and/or the plurality of rings 112. The plurality of lines 114 and/or the plurality of lines 116 may extend through the canopy fabric 110 in different directions. Different implementations may have different arrangements and/or configuration of the plurality of fixed connections 111, the plurality of rings 112 (e.g., plurality of loops), the plurality of lines 114, and/or the plurality of lines 116.

The line 105, the line 107, the line 109, the line 207 and the line 209 are coupled to the canopy fabric 110. The line 105, the line 107, the line 109, the line 207 and/or the line 209 may be coupled (e.g., directly or indirectly) to different portions of the canopy fabric 110. The line(s) may be reefing line(s), steering line(s) and/or guide line(s) for the canopy fabric 110. The line(s) 105 may be coupled to spanwise and/or chordwise reefing lines for the canopy 104. The line(s) 105 may be a reefing line. The line(s) 207 and/or the line(s) 209 may be steering lines for the canopy 104. The line 107 and/or the line 109 may be guide lines for the canopy fabric 110. The use of the above lines during deployment, steering and/or retractions are further described below.

FIG. 2 also illustrates the device 102 includes a plurality of reel devices 200. For example, the device 102 may include a first reel device 200a, a second reel device 200b, and a third reel device 200c. It is noted that different implementations of the device 102 may include a different number of reel devices. In some implementations, each of the reel devices may be considered as part of a canopy deployment, retraction and/or steering device. In some implementations, two or more of the reel devices may be collectively referred as a canopy deployment, retraction and/or steering device. Each reel device may be configured to be coupled to a particular line that is coupled to a particular part of the canopy 104 and/or the canopy fabric 110. The line 105 is coupled to the first reel device 200a. The line 207 is coupled to the second reel device 200b. The line 209 is coupled to the third reel device 200c. In some implementations, the second reel device 200b may be configured to control a reefing line for the canopy 104. In some implementations, the first reel device 200a may be configured to control a steering line for the canopy 104. In some implementations, the third reel device 200c may be configured to control another steering line for the canopy 104. The line 107 and/or the line 109 may be coupled to a respective portion (e.g., respective fixed portion) of the device 102.

One or more operations on the canopy 104 and/or the canopy fabric 110 may be controlled by controlling the lines that are attached to the canopy 104 and/or the canopy fabric 110. For example, reefing, flaring and steering can be performed on and/or by the canopy 104 and/or the canopy fabric 110.

In some implementations, reefing the canopy fabric may mean restricting and/or changing the dimensions that the canopy fabric presents to the environment, restricting the canopy fabric's ability to inflate completely and altering the resulting lift and drag characteristics the canopy fabric can produce. Being able to accurately control the timing of the reefing of the canopy fabric helps to control and contain the canopy fabric during retraction so that the canopy fabric can be properly stowed. In some implementations, steering the canopy fabric may mean using asymmetric brake deflection to alter the characteristics of the canopy fabric on one side or the other, to create a yaw and/or roll angle change of the system, the canopy and/or the canopy fabric. In some implementations, flaring the canopy fabric may mean using symmetric brake deflection to alter the lift and drag characteristics of the canopy fabric.

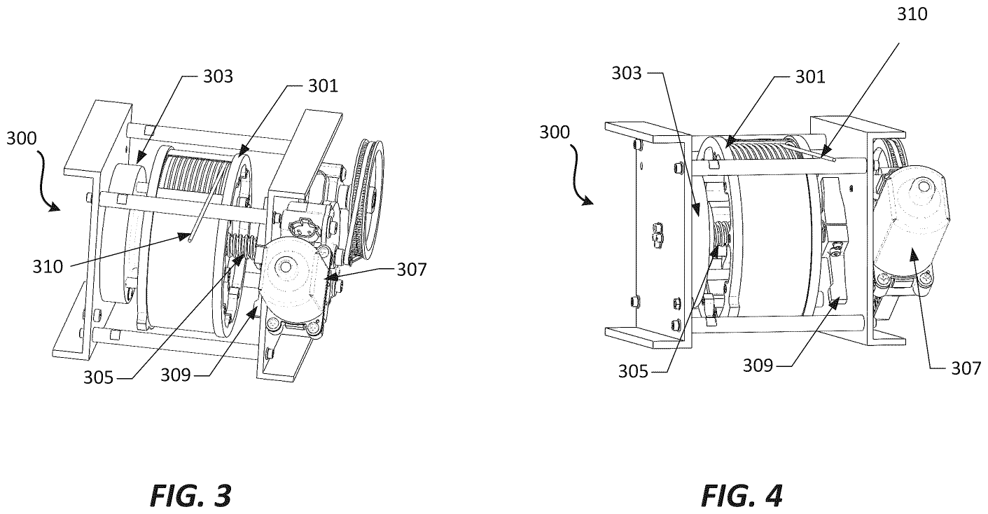

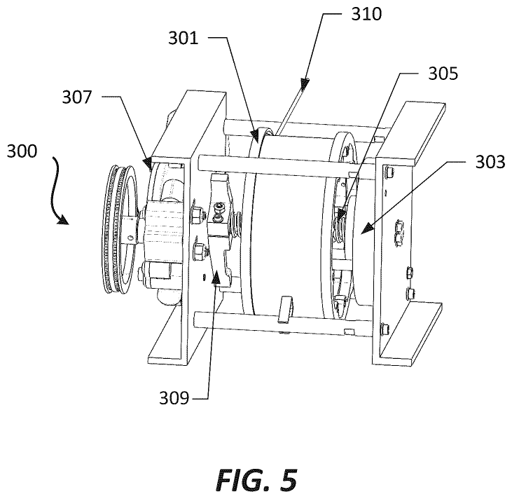

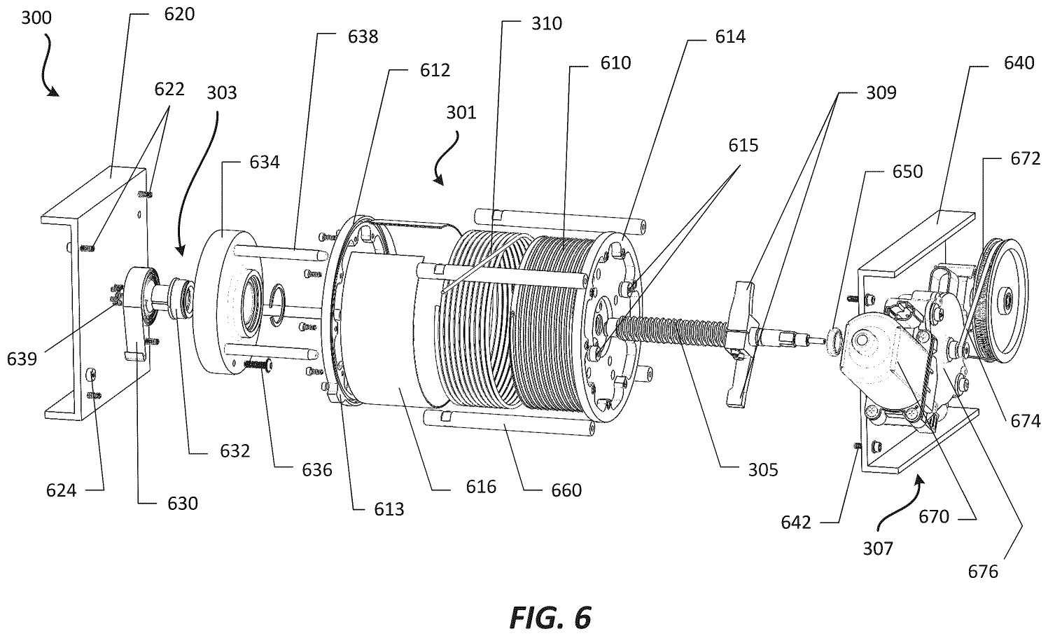

FIGS. 3-5 illustrate an example of a reel device 300 that provides line tension control. FIG. 3 illustrates a front view of the reel device 3M). FIG. 4 illustrates another front view of the reel device 3M). FIG. 5 illustrates a back view of the reel device 300. The reel device 300 may represent one or more of the reel devices 200. For the example, the reel device 200a may be implemented as the reel device 300, the reel device 200b may be implemented as the reel device 300, and/or the reel device 200c may be implemented as the reel device 300. The reel device 300 may be a canopy deployment, retraction and/or steering device. The reel device 300 includes a spool device 301, a tension controller device 303, a drive screw 305, a drive motor 307, and a stop pawl 309. As will be further described below in at least FIG. 6, the reel device 300 may include other components.

The drive screw 305 includes a threaded portion. The drive screw 305 is configured to engage through (e.g., threaded through) an opening in the spool device 301. The drive motor 307 is coupled to the drive screw 305. The drive motor 307 is configured to rotate the drive screw 305. For example, the drive motor 307 may be configured to rotate the drive screw 305 in a rotational direction (e.g., clockwise, counter clockwise). The tension controller device 303 is coupled to the spool device 301. As will be further described below, in some implementations, a rotation of the spool device 301 may cause the tension controller device 303 to wind up or unwind, depending on the direction of the rotation of the spool device 301. In some implementations, when the tension controller device 303 unwinds, it may cause the spool device 301 to rotate in a particular rotational direction.

As will be further described below, the tension controller device 303 may include a spring motor. However, in some implementations, the tension controller device 303 may include an electric motor. In some implementations, the drive motor 307 may be configured to operate as a tension controller device. That is, the drive motor 307 may rotate the drive screw 305 and/or the spool device 301 in such a way as to provide tension in the line 310.

The stop pawl 309 may be coupled (e.g., mechanically coupled) to the drive screw 305 such that the stop pawl 309 and the drive screw 305 rotate in a same rotational direction. A line 310 is coupled to the spool device 301. The line 310 may represent a line that is coupled to a canopy 104 and/or a canopy fabric 110. As will be further described below, during an operation of the canopy 104, the tension controller device 303 is configured to help control and/or provide proper tension on the line 310.

FIG. 6 illustrates an assembly view of the reel device 300. The reel device 300 includes a spool device 301, a tension controller device 303, a drive screw 305, a drive motor 307, a stop pawl 309, a first frame 620 (e.g., spring frame) and a second frame 640 (e.g., drive frame). The spool device 301 includes a spool 610 (e.g., line spool), a first spool end 612, a second spool end 614 and a shroud 616. The spool device 301 includes a spool stop pawl 613 and at least one spool stop pin 615 (e.g., one or more spool stop pins 615). The first spool end 612 may be a first spool cap end. The second spool end 614 may be a second spool cap end. The first spool end 612 and the second spool end 614 may be part of the spool 610. For example, the spool 610, the first spool end 612 and the second spool end 614 may be considered as one component. The first spool end 612 may be coupled to the spool 610 through a plurality of fasteners. The second spool end 614 may be coupled to the spool 610 through a plurality of fasteners. The spool stop pawl 613 may be part of the first spool end 612. The spool stop pawl 613 may be a protrusion from the first spool end 612. The spool stop pawl 613 may be a separate component from the first spool end 612. The spool 610 may include a helical groove. The line 310 may be coupled to the spool 610. The line 310 may be configured to be wound around the spool 610. The shroud 616 may be located around the spool 610. The shroud 616 may surround the line 310. The shroud 616 is configured to help keep the line 310 around the spool 610. There is an opening in the shroud 616 to allow the line 310 to spool in and/or unspool from the spool 610. At least one spool stop pin 615 may be coupled to the second spool end 614. Different implementations may have the at least one spool stop pin 615 to be located in different locations of the spool device 301, the spool 610 and/or the second spool end 614.

The tension controller device 303 includes a spring motor 630, a spindle 632, and a spring drive cup 634. The tension controller device 303 is coupled to the first frame 620 through a plurality of fasteners 639. For example, the plurality of fasteners 639 may be coupled to the spindle 632. The spring motor 630 is coupled (e.g., mechanically coupled) to the spindle 632. The spindle 632 may include bearings. An engagement pin 636 may be coupled to the spring drive cup 634. The engagement pin 636 may be configured to extend (e.g., thread) through the spring drive cup 634. The engagement pin 636 may be configured to be coupled to the spring motor 630. For example, the engagement pin 636 may be configured to be coupled to a long arm of the spring motor 630. A plurality of drive pins 638 are coupled to the spring drive cup 634. The plurality of drive pins 638 may be considered part of the tension controller device 303. A stop pin 624 is coupled to the first frame 620. Different implementations may couple and/or position the stop pin 624 to different locations of the first frame 620. Thus, the location of the stop pin 624 in FIG. 6, or any of the figures of the application, is exemplary.

The spindle 632 may be configured as a ground or fixed reference point, for the spring motor 630. The other end of spring motor 630, the engagement pin 636 and the spring drive cup 634 may be configured to rotate about the spindle 632. The spring motor 630 is configured to store and release spring tension and/or torque. Rotating (e.g., winding) the spring motor 630 in one rotational direction stores spring tension, and the spring motor 630 releases spring tension by rotating (e.g., unwinding) in an opposite rotational direction. The spring motor 630, the engagement pin 636 and the spring drive cup 634 are coupled to each other in such a way that rotating the spring drive cup 634 in one rotational direction, causes the engagement pin 636 and the spring motor 630 to rotate in a same rotational direction. When the spring motor 630 releases spring tension by rotating (e.g., unwinding) in an opposite rotational direction, it causes the engagement pin 636 and the spring drive cup to also rotate in the opposite direction. Thus, for example, if the spring drive cup 634 rotates in a counter clockwise direction (e.g., when viewed from the right side of FIG. 6, side of FIG. 6 that includes the drive motor 307), then the engagement pin 636 and the spring motor 630 would also rotate in a counter clockwise direction. If the spring drive cup 634 is free to rotate in a clockwise direction, then tension in spring motor 630 will drive the engagement pin 636 and spring drive cup 634 to rotate in a clockwise direction. It is noted that clockwise and counter clockwise, as used in the application, can be defined differently, depending on which perspective is used and the configuration of the drive screw 305.

The drive screw 305 is coupled (e.g., mechanically coupled) to the stop pawl 309. The stop pawl 309 may include one or more sets of arms. The arms of the stop pawl 309 may have different lengths. The drive screw 305 includes a threaded portion. The threaded portion of the drive screw 305 may be threaded clockwise or counter clockwise. The drive screw 305 is positioned in the reel device 300 such that the drive screw 305 is coupled to the tension controller device 303. However, the drive screw 305 may rotate freely relative to the tension controller device 303. That is, the rotation of the drive screw 305 does not directly affect how the spring motor 630 and/or the spring drive cup 634 rotate. This is because of the bearings of the spindle 632 and/or the bearings of the spring drive cup 634, which allows the drive screw 305 to independently rotate of the spring motor 630, the spindle 632 and/or the spring drive cup 634.

An opening in the spool 610 may be threaded. The drive screw 305 may be engaged through the opening of the spool 610 that is threaded. Thus, the drive screw 305 may be threaded through the spool 610. As described above, the drive screw 305 may also extend through an opening in the spring drive cup 634 and be in contact with bearings of the spring drive cup 634 and/or bearings of the spindle 632.

The drive motor 307 includes a motor 670, a pulley, a belt 674 and a gearbox 676. The drive motor 307 is coupled to the second frame 640 (e.g., drive frame). The motor 670 may be an electric motor. The motor 670 is coupled to the gearbox 676. The gearbox 676 may be a worm gearbox. The gearbox 676 is coupled to a belt 674. The belt 674 is coupled to a pulley 672. It is noted that gearbox 676, the belt 674 and/or the pulley 672 may be optional. The pulley 672 and/or the belt 674 may be used in determining the position of the spool 610 and/or the line 310. For example, a computing device may be coupled to the pulley 672 to determine how much the drive screw 305 and/or the spool 610 have rotated to determine how much of the line 310 has been extended and/or retracted. As an example, how much of the line 310 is extended and/or retracted can be determined by determining and/or measuring how many times the pulley 672 has rotated.

The drive screw 305 is coupled to the drive motor 307. The drive screw 305 may be coupled to the motor 670 directly or indirectly. For example, the drive screw 305 may be coupled to the gearbox 676, and the gearbox 676 is coupled to the motor 670. A bearing 650 may be used to provide support for the drive screw 305 so that the drive screw 305 rotates properly. The gearbox 676 may be controllable to be engaged or disengaged with the drive screw 305 and/or the motor 670. The motor 670 is configured to rotate (e.g., directly or indirectly) the drive screw 305. For example, the motor 670 may move one or more gears in the gearbox 676, which causes the drive screw 305 to rotate (e.g., clockwise, counterclockwise).

In some implementations, when the drive screw 305 is rotated, the spool 610 may move axially along the drive screw 305 (e.g., moves along the length of the drive screw 305). When the drive screw 305 is rotated, the threaded portion of the drive screw 305 may be in contact and/or engaged with a threaded portion of the inner portion of the opening of the spool 610, which will cause the spool 610 to move (e.g., axial movement along length of the drive screw 305). The direction in which the spool 610 moves may be dependent on the thread pattern(s) and the rotational direction of the rotation of the drive screw 305. In some implementations, rotating the drive screw 305 in a first rotational direction may cause the spool 610 to rotate in a second rotational direction that is opposite to the first direction.

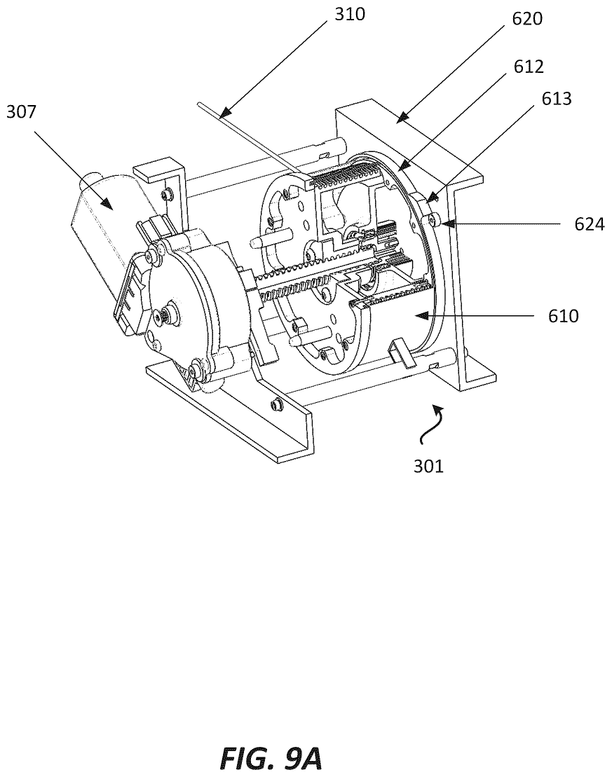

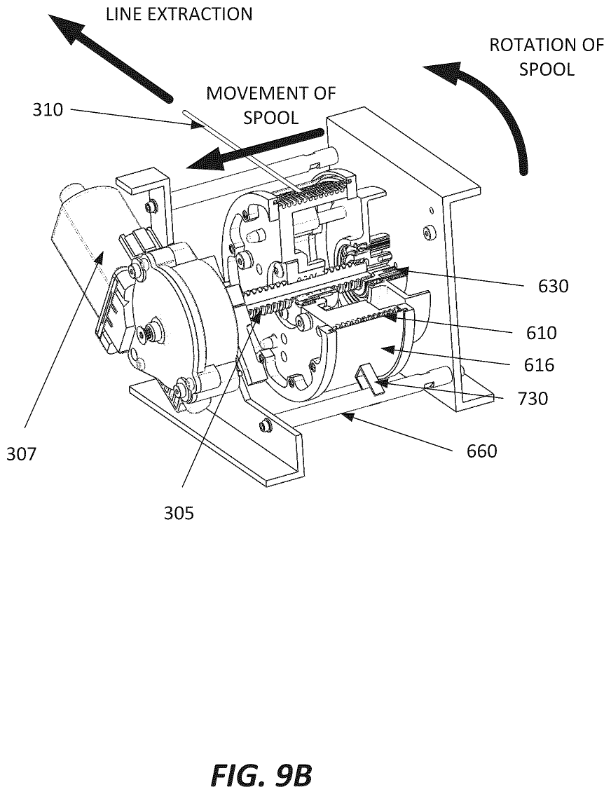

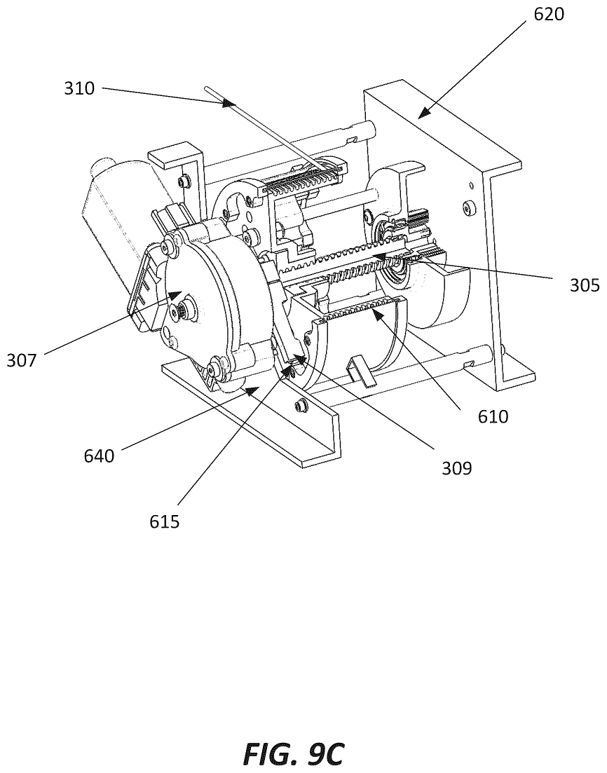

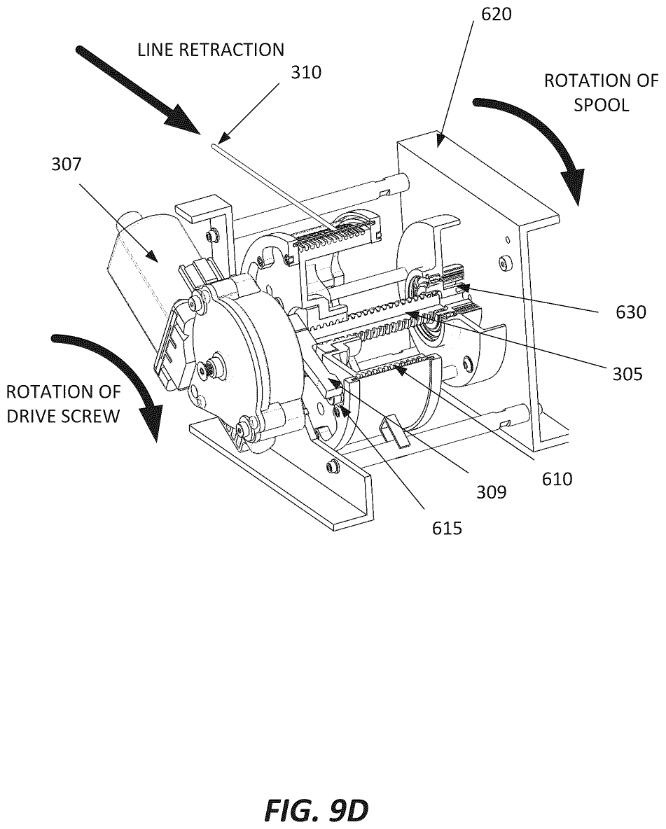

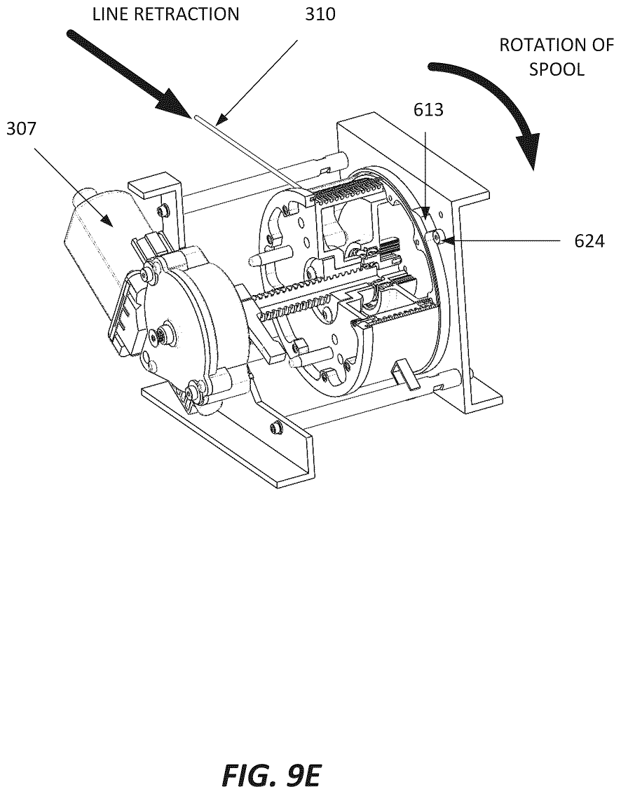

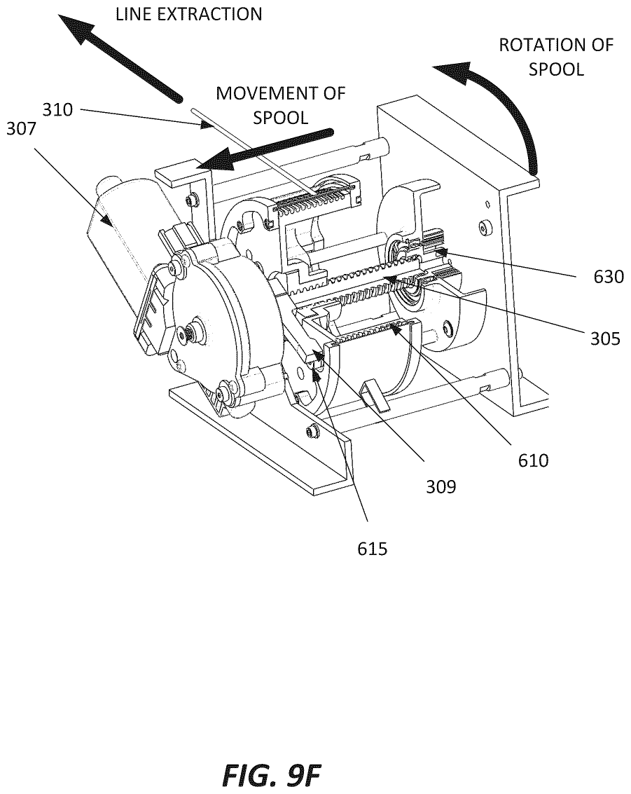

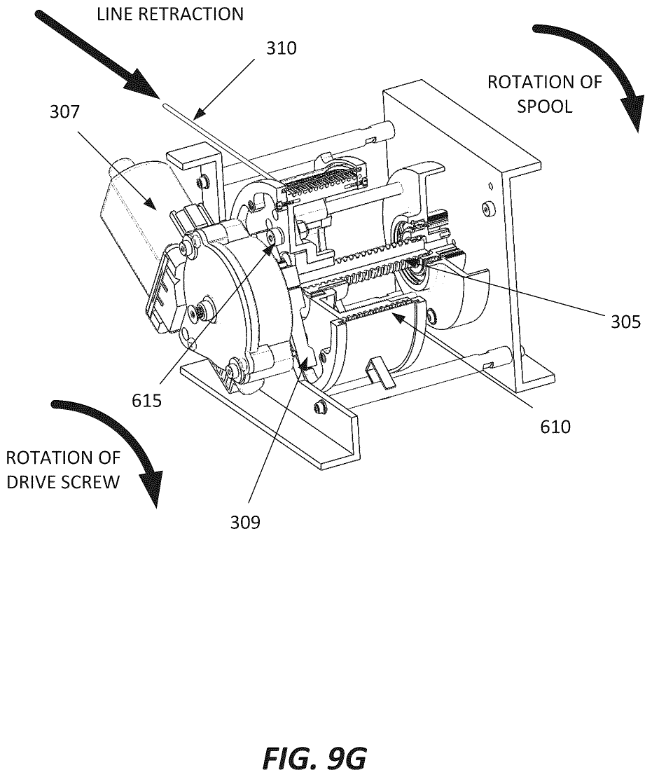

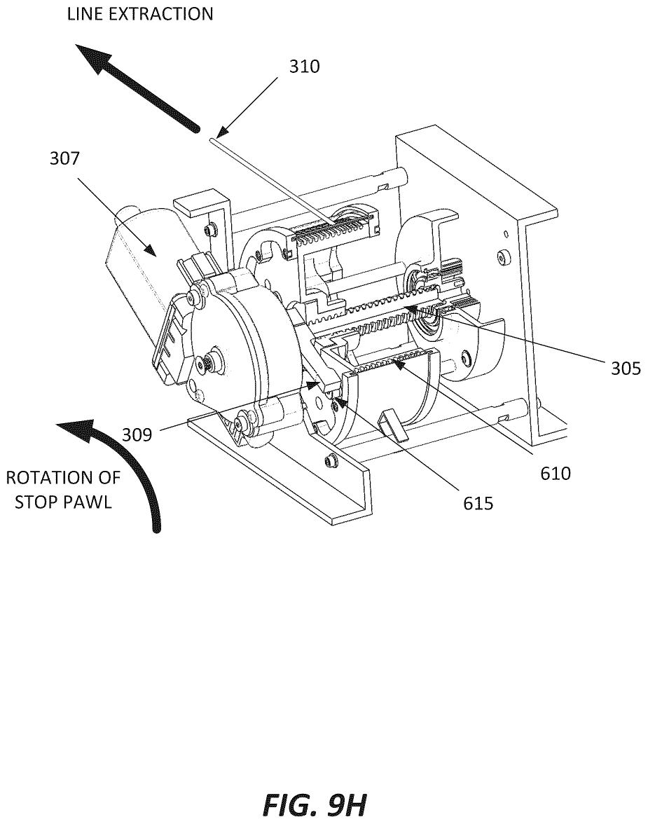

In some implementations, when the stop pawl 309 is in contact with the spool stop pin 615, rotating the drive screw 305 may cause the spool 610 to rotate in the same direction as the drive screw 305. In such implementations, the spool 610 may rotate about the drive screw 305, but may not move axially along the length of the drive screw 305. As will be further described in FIGS. 9A-9H, how the spool 610 and/or the drive screw 305 rotate will depend on various factors and/or configurations.

The plurality of drive pins 638 are coupled (e.g., coupled in a fixed manner) to the spring drive cup 634. The spring drive cup 634 may include internal bearings. The plurality of drive pins 638 may extend through openings in the first spool end 612, the second spool end 614 and the spool 610. The plurality of drive pins 638 may extend in a direction that is parallel to a direction of the length of the drive screw 305. The plurality of drive pins 638 may configured as guides and structural support for the spool 610.

The plurality of drive pins 638 are configured to transfer rotational movement of the spool 610 to a rotational movement of the spring motor 630. For example, a rotation of the spool 610 in a first rotational direction will cause the plurality of drive pins 638 to rotate in the first rotational direction, which causes the spring drive cup 634 to rotate in the first rotational direction, which causes the engagement pin 636 to rotate in the first rotational direction, and which causes the spring motor 630 to rotate in the first rotational direction, resulting in the winding or unwinding of spring tension in the spring motor 630, depending on what the first rotational direction is. The first rotational direction may be clockwise or counter clockwise.

In a similar manner, when the spring motor 630 rotates (e.g., unwinds) in a second rotational direction, the spring motor 630 causes the engagement pin 636 to rotate in the second rotational direction, which causes the spring drive cup 634 to rotate in the second rotational direction, which causes the plurality of drive pins 638 to rotate in the second rotational direction, and which causes the spool 610 to rotate in the second rotational direction. For example, if the spring motor 630 is unwinding, then this will cause the spool 610 to rotate in such a way as to retract the line 310. In some implementations, it is the use of the spring motor 630 that helps automatically control and provide tension control on the line 310. The benefit of the spring motor 630 is that the tension control is always on and does not need the help of a computing device to provide tension control on the line 310.

The first frame 620 (e.g., spring frame) is coupled to the second frame 640 (e.g., drive frame) through a plurality of spacers 660. A plurality of fasteners 622 may couple the first frame 620 to the plurality of spacers 660. A plurality of fasteners 642 may couple the second frame 640 to the plurality of spacers 660.

As will be further described below in at least FIGS. 9A-9H, the motor 670 may be used to rotate the drive screw 305 in a rotational direction (e.g., first rotational direction, second rotational direction), which may cause the spool 610 to rotate. The spool 610 may or may not move in an axial and/or linear direction (e.g., first axial/linear direction, second axial/linear direction) along the length of the drive screw 305.

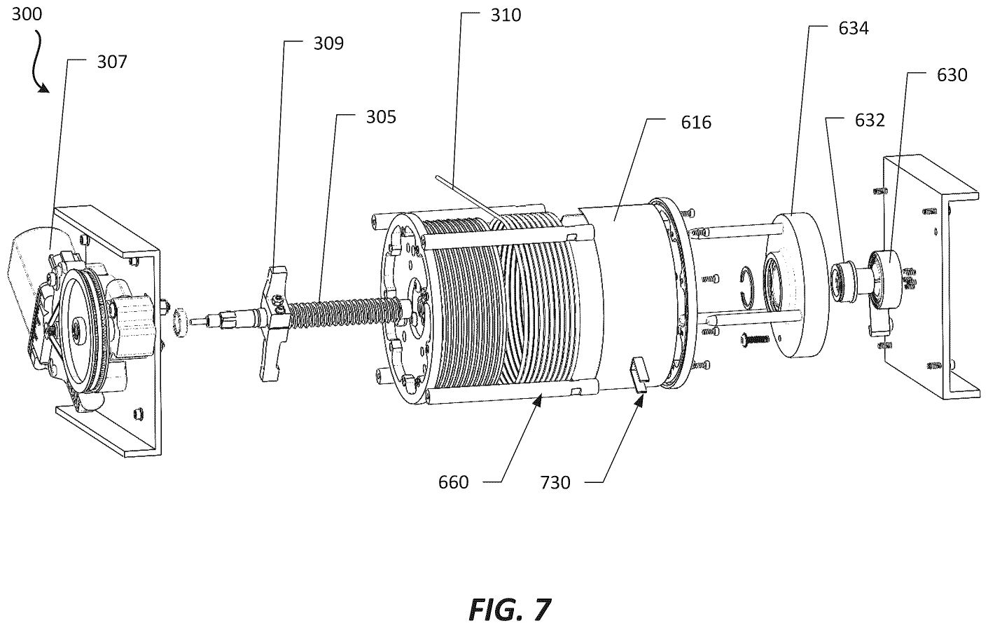

FIG. 7 illustrates a back side of the reel device 300. As shown in FIG. 7, a bracket 730 is coupled to the shroud 616. The bracket 730 is coupled to one of the spacers from the plurality of spacers 660. The bracket 730 helps ensure that the shroud 616 does not rotate as the spool 610 rotates and/or moves along the drive screw 305. The bracket 703 may move along the length of the spacer 660 as the spool 610 moves axially along the length of the drive screw 305.

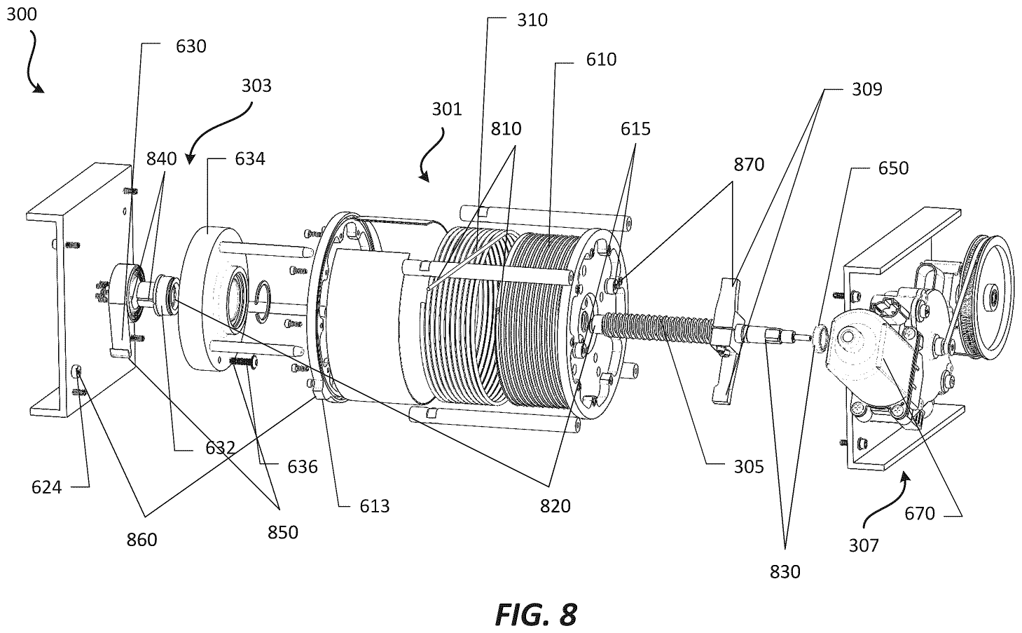

FIG. 8 illustrates the reel device 300. As shown, the line 310 is coupled to the spool 610 through a coupling 810. Different implementations may couple the line 310 to the spool 610 differently. The drive screw 305 may be threaded through a threaded opening in the spool 610. An end portion of the drive screw 305 is extended to the spindle 632. The drive screw 305 may be mounted to the spindle 632 through bearings of the spindle 632. The spindle 632 may provide support for the drive screw 305.

The drive screw 305 is coupled to the drive motor 307 through a coupling 830. For example, the drive screw 305 is coupled to the drive motor 307 through a bearing 650. Another end portion of the drive screw 305 may be coupled to the drive motor 307. The drive screw 305 may be directly or indirectly coupled to the motor 670. In one example, the drive screw 305 is coupled to the motor 670 through the gearbox 676. A rotation of the motor 670 causes the gears in the gearbox 676, which causes the drive screw 305 to rotate.

The spindle 632 may be coupled to the spring motor 630 through a coupling 840. For example, there is a part of the spring motor 630 that is coupled to a notch in the spindle 632. The spring motor 630 may also be coupled to the engagement pin 636 through a coupling 850. One end (e.g., long arm) of the spring motor 630 is coupled to the engagement pin 636. The spindle 632 holds one end (e.g., short arm) of the spring motor 630 fixed or relatively fixed, while the engagement pin 636 is configured to be coupled to another end (e.g., long arm) of the spring motor 630. The engagement pin 636 may move the long arm of the spring motor 630, which winds up the spring motor 630 and stores spring tension and/or energy (e.g., potential energy) in the spring motor 630. At some point in time, that potential energy and/or spring tension is released and unwinds the spring motor 630, which causes the spring motor 630 to rotate (e.g., unwind). As the spring motor 630 unwinds, the long arm of the spring motor 630 moves the engagement pin 636, which causes the spring drive cup 634 and the drive pins 638 to rotate in a similar rotational direction, causing the spool 610 to also rotate in a similar rotational direction.

In certain situations, the spool stop pawl 613 is configured to be coupled to the stop pin 624 through a coupling 860. The spool stop pawl 613 and the stop pin 624 are configured to limit the rotation of the spool 610 in a certain rotational direction. In some implementations, the spool 610 may rotate until the spool stop pawl 613 comes in contact with the stop pin 624, which stops the spool 610 from further rotation in a certain rotational direction.

In certain situations, the stop pawl 309 is configured to be coupled to the spool stop pin 615 through a coupling 870. The stop pawl 309 and the spool stop pin 615 are configured to limit the rotation of the spool 610 in a particular direction. In some implementations, the spool 610 may rotate until the stop pawl 309 comes in contact with the spool stop pin 615, which stops the spool 610 from further rotation in a certain rotational direction (e.g., first rotational direction, second rotational direction, clockwise rotation, counter clock wise rotation).

In some implementations, the stop pawl 309 and the spool stop pin 615 may represent one end of a rotational limit on the spool 610, while the spool stop pawl 613 and the stop pin 624 may represent another end of a rotational limit on the spool 610.

It is noted that the present application describes one or more examples of a reel device with line tension control. It is further noted that other implementations of the line tension control may include other components and/or may replace one component with another components. For example, as mentioned above, in some implementations, instead of the spring motor 630 and/or in conjunction with the spring motor 630, another motor may be coupled to the reel device. In yet another example, in some implementations, it is possible that the line tension control may be implemented and/or controlled by the motor 670. Additionally, different implementations may use different fasteners to couple two or more components together. Moreover, one or more components of the reel device may be moved to different locations without affecting how the reel device operates. In some implementations, it is possible that one or more of the components of the reel device may be optional. Thus, the implementation of the line tension control in a reel device is not limited to what is shown and/or described in the disclosure. It is noted that the size and/or shapes of various components illustrated in the disclosure is exemplary. Different implementations may have components with different shapes and/or sizes. In some implementations, one component could be coupled to another component differently. The disclosure describes that some components are mechanically coupled together through fasteners. However, in some implementations, instead of fasteners and/or in conjunction with fasteners, other types of coupling mechanisms and/or bonding mechanisms may be used to couple two or more components together, such as the use of and adhesive.

### Exemplary Sequence of an Operation of the Reel Device

FIGS. 9A-9H illustrate an exemplary sequence of an operation of the reel device 300. The operation may be a canopy deployment, retraction and/or steering operation.

It is noted that the sequence of FIGS. 9A-9H may combine one or more stages in order to simplify and/or clarify the sequence shown in FIGS. 9A-9H. In some implementations, the order of the sequence of the operation may be changed or modified. Additional operations may also be added to the sequence. Moreover, other implementations may result in a different sequence of operations.

FIG. 9A, illustrates a state of the reel device 300 where the spool 610 is located closest to the first frame 620. The spool stop pawl 613 is touching the stop pin 624. In some implementations, FIG. 9A may represent a starting position and/or starting configuration. There may be little or no load on the line 310. The drive motor 307 may not be turned on this configuration or the drive motor 307 is not rotating the drive screw 305 at this time. The spring motor 630 may be unwound or has very little spring tension.

FIG. 9B illustrates a state of the reel device 300 where there is tension on the line 310, which causes the line 310 to extend and/or unwind from the spool 610. The tension on the line 310 may come from a canopy coupled to the line 310, as the canopy is being deployed and/or steered. As the line 310 unwinds from the spool 610, the spool 610 rotates about the drive screw 305 in a first rotational direction. There is little or no rotation of the drive screw 305. The spool 610 moves axially along the length of the drive screw 305 towards the drive motor 307. As the spool 610 is unwound, the spring motor 630 is being wound up, storing potential energy and/or spring tension in the spring motor 630. The bracket 730 coupled to the shroud 616 moves along the length of the spacer 660. FIG. 9B illustrates an example of line extension by tension.

FIG. 9C illustrates a state after the spool stop pin 615 is touching the stop pawl 309. At this state, the line 310 has stopped extending, and the spool 610 is no longer able to rotate in one particular rotational direction. The spool 610 is located closest to the second frame 640 and/or the drive motor 307. At this state, the spring motor 630 may have maximum or close to maximum possible spring tension. The drive screw 305 is not rotating or may be rotating very little. FIG. 9C may illustrate a state after the line 310 has been mostly or fully extended. There may be tension in the line 310.

FIG. 9D illustrates a state after the drive motor 307 is activated, engaged, and/or turned on. This causes the drive screw 305 to rotate in a particular rotational direction, which in turns causes the spool 610 to rotate in the same rotational direction (because the stop pawl 309 is touching the spool stop pin 615). The drive screw 305 and the spool 610 are both rotating in the same direction. In this case, the spool 610 may not be moving axially along the length of the drive screw 305. However, it should be noted that the spool 610 may minimally oscillate back and forth axially along the length of the drive screw 305 as the spool 610 and the drive screw 305 rotate. As the spool 610 rotates, the spool 610 retracts the line 310. There is a load and/or tension in the line 310. As the spool 610 rotates, the spring tension in the spring motor 630 is decreasing, since the rotation of the spool 610 causes the spring motor 630 to unwind.

FIG. 9E illustrates a state after the drive motor 307 has stopped rotating the drive screw 305. Different implementations may have different criteria for stopping the drive motor 307, which may stop rotating the drive screw 305. Thus, the drive screw 305 has essentially stopped turning. However, if the tension in line 310 decreases sufficiently, energy that has been stored in the spring motor 630 keeps rotating the spool 610 such that the spool 610 retracts the line 310. In some implementations, the spool 610 may keep rotating and moving towards the first frame 620 until the spool stop pawl 613 hits the stop pin 624. In some implementations, the spool 610 may stop rotating before the spool stop pawl 613 hits the stop pin 624. FIG. 9E may illustrate a state where there is little or no spring tension in the spring motor 630, as the spring motor 630 has essentially fully unwound.

FIG. 9F illustrates a state after a tension on the line 310 has returned. However, the drive motor 307 has not engaged or turned on. The tension on the line 310 may come from a canopy coupled to the line 310. As the line 310 unwinds from the spool 610, the spool 610 rotates about the drive screw 305 in a first rotational direction. As the spool 610 rotates about the drive screw 305, the spool 610 moves along the length of the drive screw 305. The drive screw 305 is not rotating or rotating very little. As the spool 610 unwinds the line 310, spring tension is being build up in the spring motor 630, since the spool 610 is coupled to the spring drive cup 634 through the drive pins 638. The rotation of the spool 610 rotates the drive pins 638, which rotates the spring drive cup 634, which rotates the engagement pin 636, which rotates (e.g., winds up) the spring motor 630.

The spool 610 keeps rotating about the drive screw 305 until the spool stop pin 615 hits the stop pawl 309. There may be tension in the line 310. The location and/or position of the stop pawl 309 may be controlled by the drive motor 307. Thus, how much the line 310 is paid out (e.g., extended out) can be controlled by positioning the stop pawl 309 in a particular position (e.g., rotational position).

FIG. 9G illustrates a state after the drive motor 307 is activated, engaged, and/or turned on. This causes the drive screw 305 to rotate in a particular rotational direction, which in turns causes the spool 610 to rotate in the same rotational direction (because the stop pawl 309 is touching the spool stop pin 615). The drive screw 305 and the spool 610 are both rotating in the same direction. The spool 610 may not be moving axially along the length of the drive screw 305. However, it should be noted that the spool 610 may minimally oscillate back and forth axially along the drive screw 305 as the spool 610 and the drive screw 305 rotate. As the spool 610 rotates, the spool 610 retracts the line 310. There is a load and/or tension in the line 310. As the spool 610 rotates, the tension in the spring motor 630 is decreasing, since the rotation of the spool 610 causes the spring motor 630 to unwind.

FIG. 9H illustrates a state after the drive motor 307 rotates in an opposite direction than what is shown in FIG. 9G. This causes the stop pawl 309 to rotate away from the spool stop pin 615. However, the tension on the line 310 causes the spool 610 to rotate in such a manner as to make the spool stop pin 615 touch the stop pawl 309. The rotation of the spool 610 also causes the spring tension in the spring motor 630 to increase.

The above sequence illustrates one example of a sequence of how the reel device 300 may operate. However, different implementations of the reel device 300 may operate differently during extension of the line and/or retraction of the line.

It is noted that the tension on the line 310 will work against the torque on the spring motor 630, rotating the spool 610 around the drive screw 305 in the same direction as the drive motor 307 is turning, so there will be no axial motion while it winds up the spring motor 630. The spring motor 630 is configured to attempt to retract the line 310, rotating the spool 610 around the drive screw 305 in the opposite direction, where this differential rotation would move moving the spool 610 closer to the spring motor 630. The drive motor 307 rotates the payout stops (e.g., when the stop pawl 309 is in contact with the stop pin 625), allowing the spool to bottom on these stops at different payout lengths that are controllable. When the spool 610 is against the payout stops (e.g., when the stop pawl 309 is in contact with the stop pin 625), turning the drive motor 307 in one direction drives the spool, which retracts the line. However, when the spool 610 is against the payout stops (e.g., when the stop pawl 309 is in contact with the stop pin 625), turning the drive motor 307 in another direction (e.g., opposite direction) moves the payout stops away from the spool 610 (e.g., moves the stop pawl 309 away from the stop pin 625). If there is tension in the line, the line will pay out (e.g., extend) at the rate that the drive motor 307 is allowing.

If there is no tension in the line, the spring motor 630 will always attempt to retract the line 310, ensuring that there is always a proper amount of tension on the line 310 in appropriate conditions.

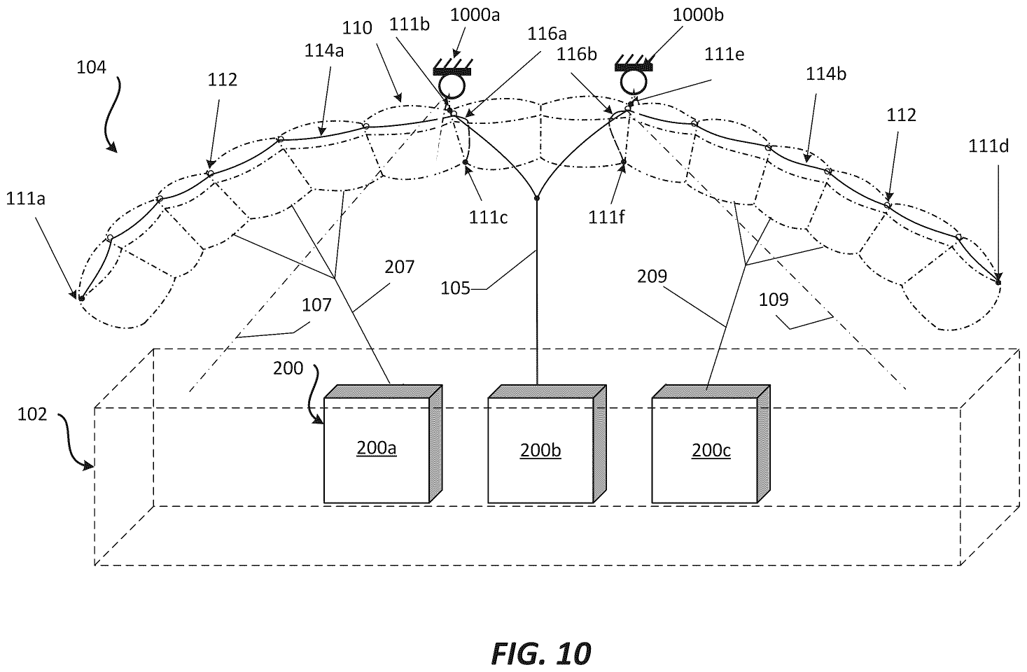

FIG. 10 illustrates the device 102 and the canopy 104. The canopy 104 of FIG. 10 is similar to the canopy 104 of FIG. 2. However, in FIG. 10, the canopy includes a plurality of guide devices 1000. The plurality of guide devices 1000 includes a first guide device 1000a and a second guide device 1000b. The guide line 107 may be configured to be coupled to and/or extend through the first guide device 1000a. The guide line 109 may be configured to be coupled to and/or extend through the second guide device 1000b. The plurality of guide devices 1000 are configured to help ensure the proper deployment and/or retraction of the canopy 104. FIG. 10 illustrates the canopy 104 that is fully deployed and/or mostly deployed.

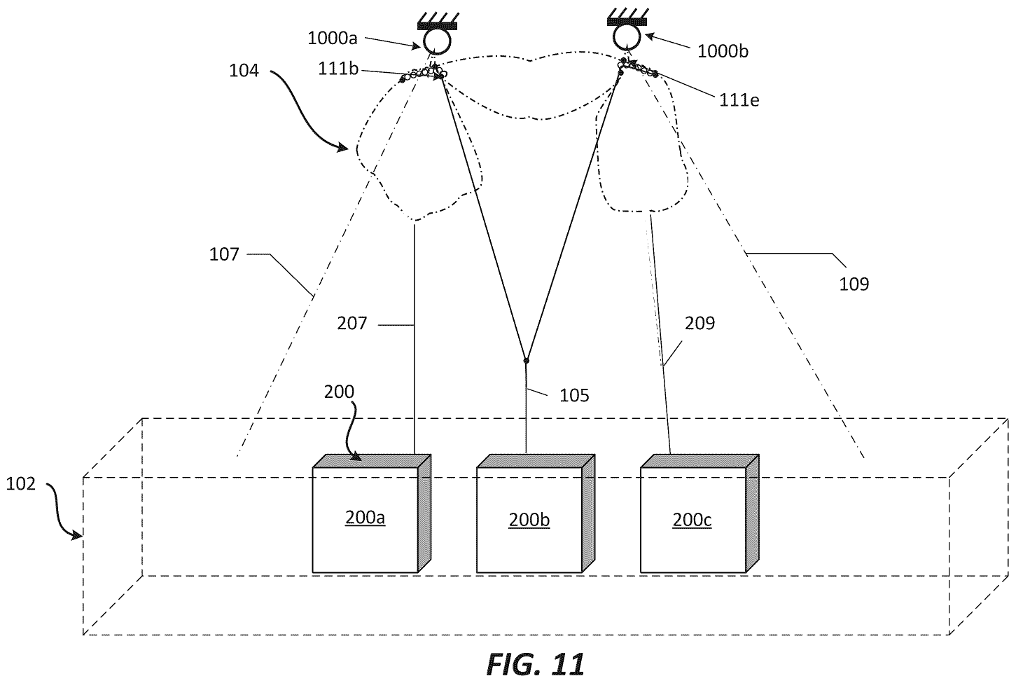

FIG. 11 may illustrate the canopy 104 of FIG. 10 after the canopy has been partially retracted. While the canopy fabric 110 is fully supported by the plurality of guide devices 1000, the line 107 and the line 109, the line 105, the line 207 and/or the line 209 are pulled down by one or more of the reel device(s) (e.g., 200a, 200b, 200c). The spanwise and chordwise lines retract towards one or more of the overhead pivot points (e.g., 111b, 111e). The canopy fabric 110 may be pulled upwards and inwards, choking airflow, depowering the canopy fabric and preventing reinflation. The lines (e.g., 114a, 114b, 116a, 116b, not labeled in FIG. 11 but labeled in at least FIG. 10) are shortened to prevent snagging on nearby objects. To re-deploy or re-inflate the canopy fabric, the line 105 and/or the line 207 and the line 209 may be controllably released.

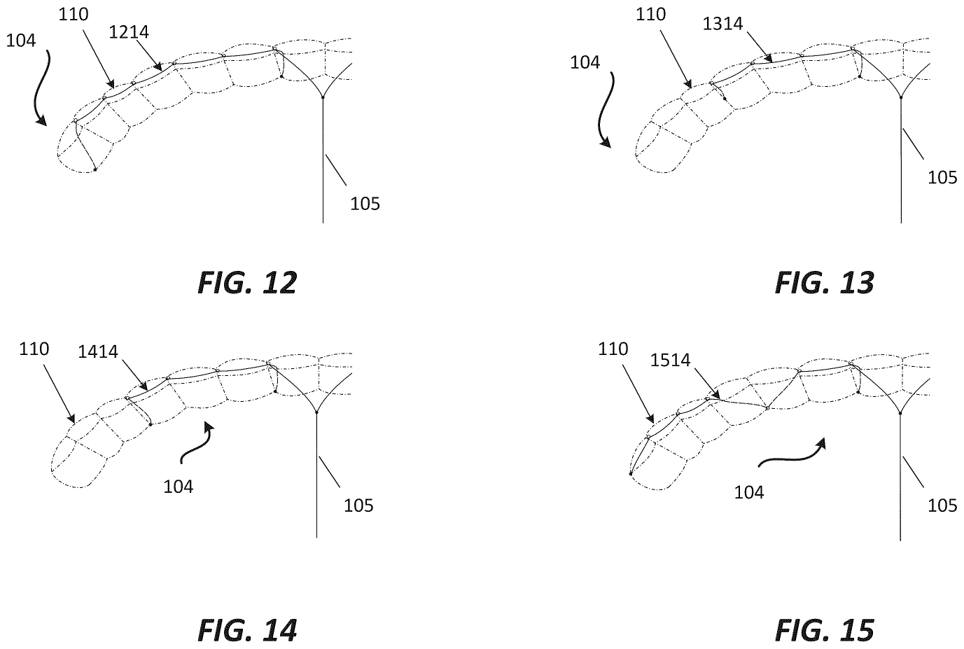

Different implementations may use a canopy with different arrangements of lines for the canopy fabric 110. FIGS. 12-15 illustrate examples of how lines may be coupled and/or looped in, through and out of a canopy fabric. FIG. 12 illustrates a line 1214 with a chordwise leg at the end of a spanwise line. The line 1214 may be similar to the line 114 of FIGS. 2 and 10. FIG. 13 illustrates a line 1314 with a partial span run, with partial chordwise leg at the end. The line 1314 may be similar to the line 114 of FIGS. 2 and 10. FIG. 14 illustrates a line 1414 with a partial span run, with a chordwise leg at the end. The line 1414 may be similar to the line 114 of FIGS. 2 and 10. FIG. 15 illustrates a line 1514 with a chordwise segment in the middle of a spanwise line. The line 1514 may be similar to the line 114 of FIGS. 2 and 10. Different implementations may use other line arrangements and/or combinations of the above line arrangements.

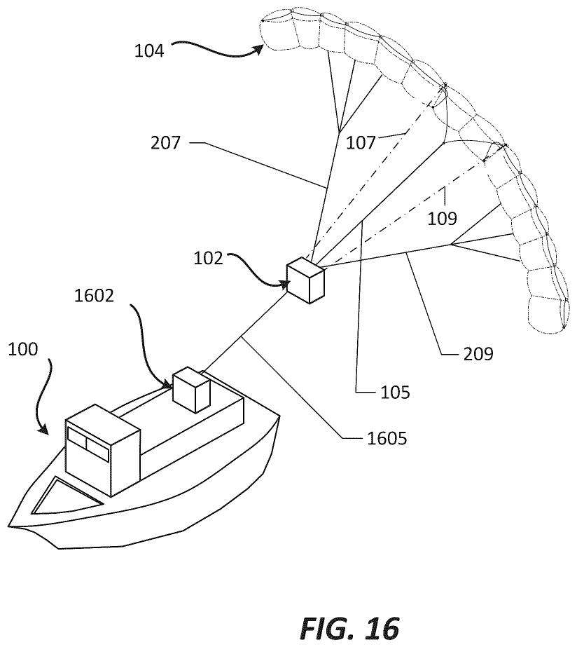

FIG. 16 illustrates an exemplary view of a vessel comprising a canopy and a canopy deployment, retraction and/or steering device with line tension control. FIG. 16 illustrates that the device 102 may be configurable to be tethered to the vessel 100 through a line 1605. Thus, the device 102 may be configured to be airborne during the operation of the canopy 104. The line 1605 is coupled to a device 1602. The line 1605 may represent one or more lines between the device 1602 and the device 102. The device 1602 may include a reel device (not shown) that can extend or retract the device 102. The reel device of the device 1602 may be similar to a reel device 200 and/or a reel device 300. The device 102 may be configurable to be launched from the device 1602 and may be retracted back towards the device 1602. In some implementations, the device 1602 may include one or more masts (e.g., extendable masts).

### Exemplary Controller for Device

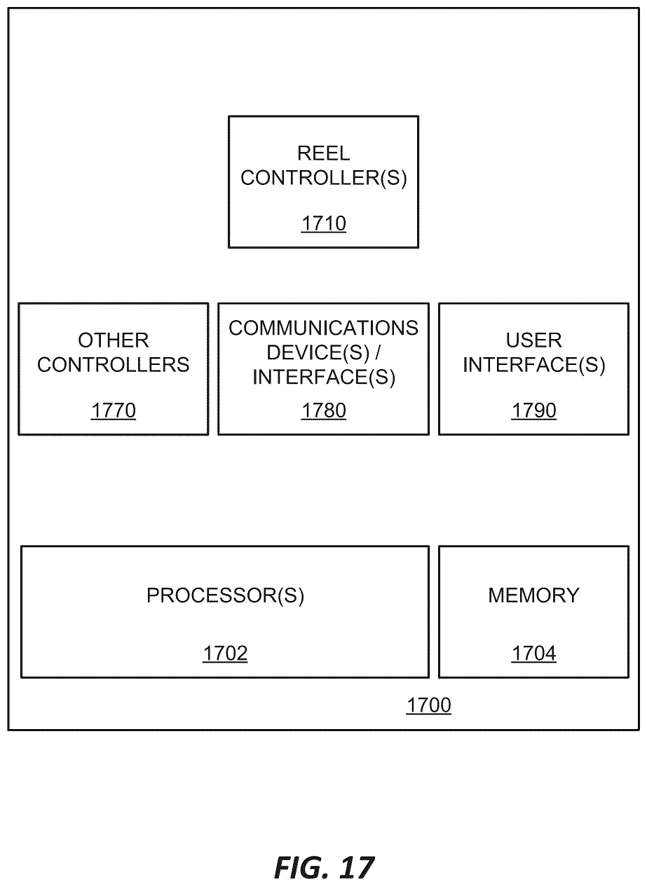

FIG. 17 illustrates a conceptual illustration of the functionalities of a controller 1700 for the device 102 and/or the reel device 200 (e.g., 200a, 200b, 200c). Configurations, functions, capabilities, operations and/or components that are described for the reel device 200 may also be applicable to the reel device 300. In some implementations, the controller 1700 is implemented within a computing device that is in communication with the device 102 and/or the reel device 200. In some implementations, the controller 1700 is the computing device in communication with the device 102 and/or reel device 200. The controller 1700 may be used to perform automated operations of the device 102 and/or the reel device 200. In some implementations, there may be several controllers 1700 that may be located in different locations. In some implementations, the controller 1700 is a conceptual example of the computing device. The controller 1700 may be implemented as hardware (e.g., processor, die, integrated device), software (e.g., non-transitory processor readable medium), and/or combinations thereof, in one or more devices (e.g., processor, chip, computer, tablet, mobile device).

As shown in FIG. 17, the controller 1700 includes one or more processors 1702, one or more memory storage 1704, one or more reel controllers 1710, one or more other controllers 1770, one or more communications devices 1780, and/or one or more user interfaces 1790. In some implementations, the above functions may be implemented in one or more controllers, devices, dies and/or integrated devices.

The processor 1702, the memory storage 1704 and/or combinations thereof, may be configured to process or perform operations with the one or more reel controllers 1710, one or more other controllers 1770, one or more communications devices 1780, and/or one or more user interfaces 1790.

The one or more reel controllers 1710 are configured to control the operation of the reel device 300. The one or more reel controllers 1710 may be configured to control the reefing, flaring and/or steering of a canopy through the control of the operation of the reel device 300. The one or more reel controllers 1710 may be configured to measure how far the line(s) has/have been extended and/or retracted. As such, the one or more reel controllers 1710 may be configured to determine the position of the lines and/or the canopy. The communication devices 1780 may include different devices and/or interfaces to communicate with different devices (e.g., sensors) and/or components. The communication devices 1780 may include a bus interface, a wired interface, wireless interface (e.g., Wireless Fidelity (WIFI), Bluetooth, radio, cellular, etc. . . . ), and/or an optical interface.

The user interfaces 1790 allow an operator to control and monitor the operation of the device 102 locally and/or remotely. For example, the user interfaces 1790 may allow an operator to remotely control the device 102. The user interfaces 1790 may also allow an operator to remotely control devices (e.g., sensor, camera, antenna) coupled to the device 102. However, it is noted that the device 102 may operate autonomously. Thus, many of the operations described in the present disclosure may be performed without input from a human and/or the presence of a human at the device 100.

One or more of the components, processes, features, and/or functions illustrated in FIGS. 1-8, 9A-9H, and/or 10-17 may be rearranged and/or combined into a single component, process, feature or function or embodied in several components, processes, or functions. Additional devices, elements, components, processes, and/or functions may also be added without departing from the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The disclosure describes various materials, components and/or parts for coupling objects together. However, it is noted that other materials, components and/or parts may be used to couple objects together. The term “about ‘value X’”, or “approximately value X”, as used in the disclosure shall mean within 10 percent of the ‘value X’. For example, a value of about 1 or approximately 1, would mean a value in a range of 0.9-1.1.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Any of the above methods and/or processes may also be code that is stored in a computer/processor readable storage medium that can be executed by at least one processing circuit, processor, die and/or controller. For example, the controller may include one or more processing circuits that may execute code stored in a computer/processor readable storage medium. A computer/processor readable storage medium may include a memory (e.g., memory die, memory in a logic die, memory controller). A die may be implemented as a flip chip, a wafer level package (WLP), and/or a chip scale package (CSP).

Those of skill in the art would further appreciate that the various illustrative logical blocks, modules, circuits, and algorithm steps described in connection with the embodiments disclosed herein may be implemented as electronic hardware, computer software, and/or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.
Aspect 1: A vehicle comprising a first device and a canopy. The first device comprises a first spool device; a first drive screw comprising a threaded portion, wherein the first drive screw is configured to extend through an opening in the first spool device; a first drive motor coupled to the first drive screw, wherein the first drive motor is configured to rotate the first drive screw; a first tension controller device coupled to the first spool device; and a first stop pawl coupled to the first drive screw. The canopy comprises a canopy fabric; and a first line. The canopy is coupled to the first spool device through the first line.
Aspect 2: The aspect 1, where the vehicle also comprises a second device. The second device comprises a second spool device; a second drive screw comprising a threaded portion, wherein the second drive screw is configured to extend through an opening in the second spool device; a second drive motor coupled to the second drive screw, wherein the second drive motor is configured to rotate the second drive screw; a second tension controller device coupled to the second spool device; and a second stop pawl coupled to the second drive screw. The canopy includes a second line. The canopy is coupled to the second spool device through the second line.
Aspect 3: The aspect 1 or 2, where the vehicle also comprises a third device. The third device comprises a third spool device; a third drive screw comprising a threaded portion, wherein the third drive screw is configured to extend through an opening in the third spool device; a third drive motor coupled to the third drive screw, wherein the third drive motor is configured to rotate the third drive screw; a third tension controller device coupled to the third spool device; and a third stop pawl coupled to the third drive screw. The canopy includes a third line. The canopy is coupled to the third spool device through the third line.

The various features of the disclosure described herein can be implemented in different devices and/or systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. A device comprising:
a spool device;
a drive screw comprising a threaded portion, wherein the drive screw is configured to extend through an opening in the spool device;
a drive motor coupled to the drive screw, wherein the drive motor is configured to rotate the drive screw;
a tension controller device coupled to the spool device; and
a stop pawl coupled to the drive screw.

2. The device of claim 1, wherein the tension controller device is configured to rotate the spool device.

3. The device of claim 2, wherein the tension controller device rotating the spool device causes the spool device to move toward the tension controller device.

4. The device of claim 1, wherein the spool device is configurable to cause spring tension to be built up in the tension controller device.

5. The device of claim 1, wherein the stop pawl is configured to stop the spool device from rotating in a direction.

6. The device of claim 1, wherein the tension controller device includes a spring motor.

7. The device of claim 6,
wherein the tension controller device further comprises:
a spindle;
a spring drive cup; and
an engagement pin coupled to the spring drive cup,
wherein the spring drive cup is coupled to the spring motor through the engagement pin.

8. The device of claim 7, wherein the tension controller device further includes a plurality of drive pins coupled to the spring drive cup, wherein the plurality of drive pins are configured to be coupled to the spool device.

9. The device of claim 1, further comprising a line coupled to the spool device.

10. The device of claim 9,
wherein the device is coupled to a canopy through the line coupled to the spool device, and
wherein the canopy comprises a canopy fabric and a plurality of lines.

11. The device of claim 1, wherein the spool device comprises:
a spool;
a spool stop pawl; and
a spool stop pin.

12. The device of claim 11, wherein the spool device further comprises a shroud.

13. The device of claim 1, wherein the drive motor comprises:
a motor; and
a gearbox coupled to the drive screw.

14. A vehicle comprising:
a first device comprising:
a first spool device;
a first drive screw comprising a threaded portion, wherein the first drive screw is configured to extend through an opening in the first spool device;
a first drive motor coupled to the first drive screw, wherein the first drive motor is configured to rotate the first drive screw;
a first tension controller device coupled to the first spool device; and
a first stop pawl coupled to the first drive screw; and
a canopy comprising:
a canopy fabric; and
a first line,
wherein the canopy is coupled to the first spool device through the first line.

15. The vehicle of claim 14, further comprising a second device comprising:
a second spool device;
a second drive screw comprising a threaded portion, wherein the second drive screw is configured to extend through an opening in the second spool device;
a second drive motor coupled to the second drive screw, wherein the second drive motor is configured to rotate the second drive screw;
a second tension controller device coupled to the second spool device; and
a second stop pawl coupled to the second drive screw; and
wherein the canopy includes a second line, and
wherein the canopy is coupled to the second spool device through the second line.

16. The vehicle of claim 15,
wherein the first line a reefing line for the canopy, and
wherein the second line is a first steering line for the canopy.

17. The vehicle of claim 15, further comprising a third device comprising:
a third spool device;
a third drive screw comprising a threaded portion, wherein the third drive screw is configured to extend through an opening in the third spool device;
a third drive motor coupled to the third drive screw, wherein the third drive motor is configured to rotate the third drive screw;
a third tension controller device coupled to the third spool device; and
a third stop pawl coupled to the third drive screw; and
wherein the canopy includes a third line, and
wherein the canopy is coupled to the third spool device through the third line.

18. The vehicle of claim 14, wherein the first tension controller device includes a first spring motor.

19. The vehicle of claim 18,
wherein the first tension controller device further comprises:
a spindle;
a spring drive cup; and
an engagement pin coupled to the spring drive cup,
wherein the spring drive cup is coupled to the first spring motor through the engagement pin.

20. The vehicle of claim 14, wherein the water borne vehicle includes a vessel, a ship, a catamaran, a platform, a land based vehicle, a water borne vehicle, an air based vehicle and/or an amphibious vehicle.

21. The vehicle of claim 14,
wherein the canopy further comprises a plurality of reefing lines coupled to the line; and
wherein the plurality of reefing lines may include at least one chordwise reefing line and/or at least one spanwise reefing line.

22. The vehicle of claim 21, wherein the plurality of reefing lines are coupled to the canopy fabric through a plurality of loops.

23. The vehicle of claim 22, wherein the plurality of reefing line are configured to control the shape of the canopy, by pulling or releasing on one or more reefing lines from the plurality of reefing lines.
